(19) United States
(12) Patent Application Publication
(10) Pub. No.: US 2019/0213561 A1
(43) Pub. Date: Jul. 11, 2019

(54) TASK MANAGEMENT SYSTEM AND THE METHOD THEREOF

(71) Applicant: Varun BHUTANI, New Delhi (IN)

(72) Inventor: Varun BHUTANI, New Delhi (IN)

(21) Appl. No.: 16/315,054

(22) PCT Filed: Jul. 4, 2017
(86) PCT No.: PCT/IB2017/054035

§ 371 Date: Jan. 3, 2019

(30) Foreign Application Priority Data
Jul. 4, 2016 (IN) 201611022865

(51) Int. Cl. G06Q 10/10; G06Q 10/06

(52) U.S. Cl. CPC G06Q 10/1097; G06Q 10/063114; G06Q 10/063112

(57) ABSTRACT

There is provided a method (200) for task management including steps of receiving (202) a plurality of tasks generated at a first user device corresponding to a first user, receiving (204) a plurality of assignment schedules corresponding the plurality of respective tasks, from the first user device, assigning (206) the plurality of tasks to a plurality of second users, on basis of the plurality of assignment schedules, notifying (208) a plurality of second user devices, corresponding to the plurality of respective second users, of the plurality of tasks, and receiving (210) progress information corresponding to the plurality of tasks from the plurality of second user devices. Further, a system (700) for task management is provided.

### CROSS-REFERENCE TO RELATED APPLICATIONS

This application is a national stage application of International Patent Application PCT/IB2017/054035, filed Jul. 4, 2017, which itself claims the priority to Indian Patent Application No. IN 201611022865, filed Jul. 4, 2016 in the Intellectual Property India, both of which are expressly incorporated by reference herein in their entirety.

Some references, which may include patents, patent applications, and various publications, are cited and discussed in the description of the present disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FILED OF THE DISCLOSURE

The present disclosure relates to database management systems and methods and more particularly relates to a task management system and a method thereof.

### BACKGROUND OF THE DISCLOSURE

Adequate task management is backbone of any organization today, especially organization with large number of workforce, and multiple location across the globe. However, conventional solutions require numerous working hours in processing email and tasks among users. Task managers typically receive numerous email messages each day that they need to process. Additionally, the complex structure of such conventional task management systems hamper the efficiency of task managers to get things done in terms of processing emails and tasks thereby effect the overall project deliveries and timelines. There have been a number of solutions provided for efficient task management and few of them have been discussed below:

US Patent Publication No. US20150143258A1 discloses a solution to integrate email and task management where users are provided with options to convert an email into a task, including one-click command options. The integration is enabled by triaging of incoming emails, integration of various email systems and third party services, converting emails into a To-Do items and adding email items to an electronic calendar.

U.S. Pat. No. 8,639,552B2 talks about solution for creating and sharing tasks over one or more networks. The solution employs a message retrieval module which is configured to retrieve electronic messages and parse them into a plurality of tasks. Further, a multi-layer network management module is disclosed which organizes the tasks and task participants into multiple networks and clouds and into a federation of clouds. Whereas, U.S. Pat. No. 8,082,308B2 attempted to provide a solution for managing tasks by segregating emails with specific subjects related to tasks, users and projects. In other words, the subject line of the e-mail is parsed for the task identification like name of the task, due date, groups and tasks description properties.

The aforesaid documents and other similar solutions may strive to provide efficient task management systems; however, they still have a number of limitations and shortcomings such as, but not limited to, inefficient timeline monitoring of tasks, communication gaps between members of same group performing different sub-tasks, limited number of sub-tasks and unnecessary notifications of tasks.

Therefore, there remains a need in the art for an improved task management system and method which will overcome or substantially ameliorate at least some of the deficiencies of the prior art, or to at least provide an alternative.

### SUMMARY OF THE DISCLOSURE

According to one aspect of the present disclosure, a task management system and a method thereof is provided. The present disclosure is described hereinafter by various embodiments. This disclosure may, however, be embodied in many different forms and should not be construed as limited to the embodiment set forth herein. Detailed embodiments of the present disclosure are described herein; however, it is to be understood that disclosed embodiments are merely exemplary of the present disclosure, which may be embodied in various alternative forms. Specific process details disclosed herein are not to be interpreted as limiting, but merely as a representative basis for teaching one skilled in the art to variously employ the present disclosure in any appropriate process.

Embodiments of the present disclosure aim to provide a method and a system for task management. The present disclosure provides a system for receiving a plurality of tasks generated at a first user device corresponding to a first user. Further, the plurality of tasks is assigned to a plurality of second users, on basis of the plurality of assignment schedules. Further, the present disclosure notifies a plurality of second user devices, corresponding to the plurality of respective second users, of the plurality of tasks. The present disclosure further provides, but not limited to, efficient timeline monitoring of tasks, communication between members of same group performing different sub-tasks through messaging channel and integration and customization of notifications and reminders on Google drive, Google calendar.

According to the first aspect of the disclosure, a method for task management is disclosed. A method for task management comprises steps of, but not limited to, receiving a plurality of tasks generated at a first user device corresponding to a first user, receiving a plurality of assignment schedules corresponding the plurality of respective tasks, from the first user device, assigning the plurality of tasks to a plurality of second users, on basis of the plurality of assignment schedules, notifying a plurality of second user devices, corresponding to the plurality of respective second users, of the plurality of tasks and receiving progress information corresponding to the plurality of tasks from the plurality of second user devices.

In accordance with embodiment of the disclosure, the plurality of tasks has been divided into a hierarchical structure having a plurality of levels, execution of a task at one level being dependent on execution of another task at a subordinate level.

In accordance with embodiment of the disclosure, the plurality of assignment schedules comprises a plurality of respective time schedules corresponding to the plurality of respective tasks.

In accordance with embodiment of the disclosure, the plurality of assignment schedules comprises assignment of the plurality of respective tasks to the plurality of second users, on basis of a plurality of parameters.

In accordance with embodiment of the disclosure, the plurality of parameters comprises respective designations, skill levels, availabilities and locations of the plurality of second users.

In accordance with embodiment of the disclosure, the method further comprises a step of storing the plurality of tasks and the plurality of assignment schedules in a storage device.

In accordance with embodiment of the disclosure, the method further comprises a step of providing a messaging channel between the first user device and a second user device, of the plurality of second user devices.

In accordance with embodiment of the disclosure, one or more tasks, of the plurality of tasks, are assigned to a second user, of the plurality of second users.

In accordance with embodiment of the disclosure, the method further comprises a step of receiving one or more responses corresponding to the one or more respective tasks, from the second user device.

In accordance with embodiment of the disclosure, a task, of the plurality of tasks, is assigned to one or more second users, of the plurality of second users.

In accordance with embodiment of the disclosure, the method further comprises a step of receiving one or more responses corresponding to the task from the one or more respective second user devices.

In accordance with embodiment of the disclosure, the method further comprises a step of receiving a plurality of priority ratings corresponding to the plurality of tasks, from the plurality of second user devices.

In accordance with embodiment of the disclosure, the plurality of second users is notified through a cloud-based calendar service.

In accordance with embodiment of the disclosure, the method further comprises a step of receiving a transfer of ownership of one or more of the plurality of tasks from the first user device, the ownership being transferred from the first user to another first user.

In accordance with embodiment of the disclosure, the method further comprises a step of generating a plurality of progress reports corresponding to the plurality of respective tasks and transmitting the plurality of tasks to the first user device.

In accordance with embodiment of the disclosure, the method further comprises a step of displaying a task, of the plurality of tasks, and a respective progress report, of the plurality of progress reports, at the first user device, the task being displayed in a first window and the progress report being displayed in a second window, wherein the first window and the second window are displayed in alternative, at the first user device.

In accordance with embodiment of the disclosure, the method further comprises a step of sending e-mail to the one or more respective second user devices corresponding to the task.

In accordance with embodiment of the disclosure, a system for task management comprises, but not limited to, an interface module, an assignment module, and a data management module. Further, the interface module is configured to receive a plurality of tasks generated at a first user device corresponding to a first user. The interface module is further configured to receive a plurality of assignment schedules corresponding the plurality of respective tasks, from the first user device. Further, the assignment module is configured to assign the plurality of tasks to a plurality of second users, on basis of the plurality of assignment schedules. The assignment module is further configured to notify a plurality of second user devices, corresponding to the plurality of respective second users, of the plurality of tasks. Further, the data management module is configured to receive progress information corresponding to the plurality of tasks from the plurality of second user devices.

In accordance with embodiment of the disclosure, the data management module is further configured to store the plurality of tasks and the plurality of assignment schedules in a storage device.

In accordance with embodiment of the disclosure, the system further comprising communication module configured to provide a messaging channel between the first user device and a second user device, of the plurality of second user devices.

In accordance with embodiment of the disclosure, the assignment module is further configured to assign one or more tasks, of the plurality of tasks, to a second user, of the plurality of second users.

In accordance with embodiment of the disclosure, the interface module is further configured to receive one or more responses corresponding to the one or more respective tasks, from the second user device.

In accordance with embodiment of the disclosure, the assignment module is further configured to assign a task, of the plurality of tasks, to one or more second users, of the plurality of second users.

In accordance with embodiment of the disclosure, the interface module is further configured to receive one or more responses corresponding to the task from the one or more respective second user devices.

In accordance with embodiment of the disclosure, the data management module is further configured to receive a plurality of priority ratings corresponding to the plurality of tasks, from the plurality of second user devices.

In accordance with embodiment of the disclosure, the assignment module is further configured to notify the plurality of second users through a cloud based calendar service.

In accordance with embodiment of the disclosure, the data management module is further configured to receive a transfer of ownership of one or more of the plurality of tasks from the first user device, the ownership being transferred from the first user to another first user.

In accordance with embodiment of the disclosure, the system further comprises reporting module configured to generate a plurality of progress reports corresponding to the plurality of respective tasks and transmit the plurality of progress reports to the first user device.

In accordance with embodiment of the disclosure, the interface module is further configured to display a task, of the plurality of tasks, and a respective progress report, of the plurality of progress reports, at the first user device, the task being configured to be displayed in a first window and the progress report being configured to be displayed in a second window, wherein the first window and the second window are configured to be displayed in alternative, at the first user device.

In accordance with embodiment of the disclosure, the system further comprises e-mail module configured to send e-mail to the one or more respective second user devices corresponding to the task.

### BRIEF DESCRIPTION OF DRAWINGS

So that the manner in which the above recited features of the present disclosure can be understood in detail, a more particular description of the disclosure, briefly summarized above, may have been referred by examples, some of which are illustrated in the appended drawings. It is to be noted, however, that the appended drawings illustrate only typical examples of this disclosure and are therefore not to be considered limiting of its scope, for the disclosure may admit to other equally effective examples.

These and other features, benefits, and advantages of the present disclosure will become apparent by reference to the following text figure, with like reference numbers referring to like structures across the views, wherein:

FIG. 1 illustrates an exemplary environment diagram to which various embodiments of the present disclosure may be implemented;

FIG. 2 illustrates a method for task management, in accordance with an embodiment of the present disclosure;

FIG. 3A illustrates a snapshot of a plurality of tasks, in accordance with an embodiment of the present disclosure;

FIG. 3B illustrates a snapshot of a plurality of options, in accordance with an embodiment of the present disclosure;

FIG. 3C illustrates a snapshot of a timesheet, in accordance with an embodiment of the present disclosure;

FIG. 4 illustrates a snapshot of the plurality of options for the notification in a drop down menu, in accordance with an embodiment of the present disclosure;

FIG. 5 illustrates a snapshot of a messaging channel, in accordance with an embodiment of the present disclosure;

FIG. 6 illustrates a snapshot of a progress report, in accordance with an embodiment of the present disclosure; and

FIG. 7 illustrates a system for task management, in accordance with an embodiment of the present disclosure.

### DETAILED DESCRIPTION OF THE ACCOMPANYING DRAWINGS

While the present disclosure is described herein by way of example using embodiments and illustrative drawings, those skilled in the art will recognize that the disclosure is not limited to the embodiments of drawing or drawings described, and are not intended to represent the scale of the various components. Further, some components that may form a part of the disclosure may not be illustrated in certain figures for ease of illustration, and such omissions do not limit the embodiments outlined in any way. It should be understood that the drawings and detailed description thereto are not intended to limit the disclosure to the particular form disclosed, but on the contrary, the disclosure is to cover all modifications, equivalents and alternatives falling within the scope of the present disclosure as defined by the appended claim. As used throughout this description, the word “may” is used in a permissive sense (i.e. meaning having the potential to), rather than the mandatory sense (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present disclosure. It is not suggested or represented that any or all of these matters form part of the prior art base or were common general knowledge in the field relevant to the present disclosure.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present disclosure is described hereinafter by various embodiments with reference to the accompanying drawing, wherein reference numerals used in the accompanying drawing correspond to the like elements throughout the description. This disclosure may, however, be embodied in many different forms and should not be construed as limited to the embodiment set forth herein. Rather, the embodiment is provided so that this disclosure will be thorough and complete and will fully convey the scope of the disclosure to those skilled in the art. In the following detailed description, numeric values and ranges are provided for various aspects of the implementations described. These values and ranges are to be treated as examples only, and are not intended to limit the scope of the claims. In addition, numbers of materials are identified as suitable for various facets of the implementations. These materials are to be treated as exemplary and are not intended to limit the scope of the disclosure.

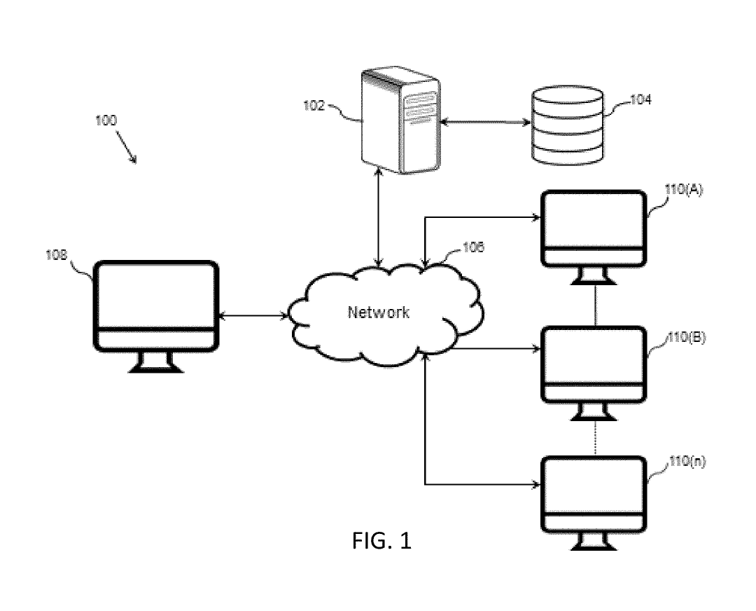

Referring to the drawings, the disclosure will now be described in more details. FIG. 1 illustrates an exemplary environment (100) diagram to which various embodiments of the present disclosure may be implemented. As shown in FIG. 1, the environment (100) comprises a first user device (108) and a plurality of second user devices (110(A), 110(B), 110(n)) connected to a server (102) through a network (106) by any suitable means, such as, for example, hardwired and/or wireless connections, such as dial-up, hardwired, cable, Digital Subscriber Line (DSL), satellite, cellular, Personal Communications Service (PCS), wireless transmission. Further, the network 106 is one of, but not limited to, a Local Area Network (LAN) or a Wide Area Network (WAN). Preferably, the network (106) is internet.

In accordance with an embodiment of the disclosure, the server (102) is web server and/or an API server. Further, the server (102) is capable of communicating using various protocols, such as Transmission Control Protocol/Internet Protocol (TCP/IP), File Transfer Protocol (FTP), Hypertext Transfer Protocol (HTTP), etc. and secure protocols such as Internet Protocol Security Protocol (IPsec), Point-to-Point Tunneling Protocol (PPTP), Secure Sockets Layer (SSL) Protocol or other equivalent protocols. The server (102) in turn is operably connected to a storage device (104). In accordance with an embodiment, the storage device (104) is configured to process queries in a plurality of languages comprising of, but not limited to, Structured Query Language (SQL), .QL and Datalog etc. In accordance with an embodiment, the storage device (104) is a cloud based storage device (104). In accordance with another embodiment, the storage device (104) is a local storage device or a dedicated web based storage device.

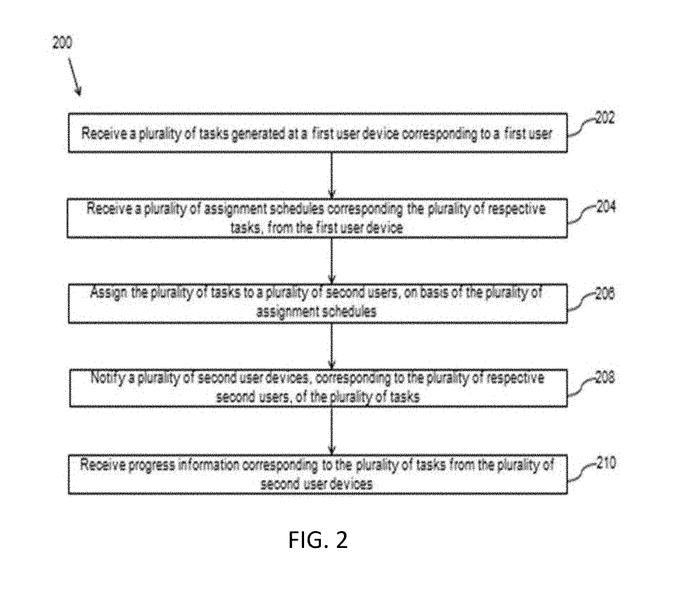

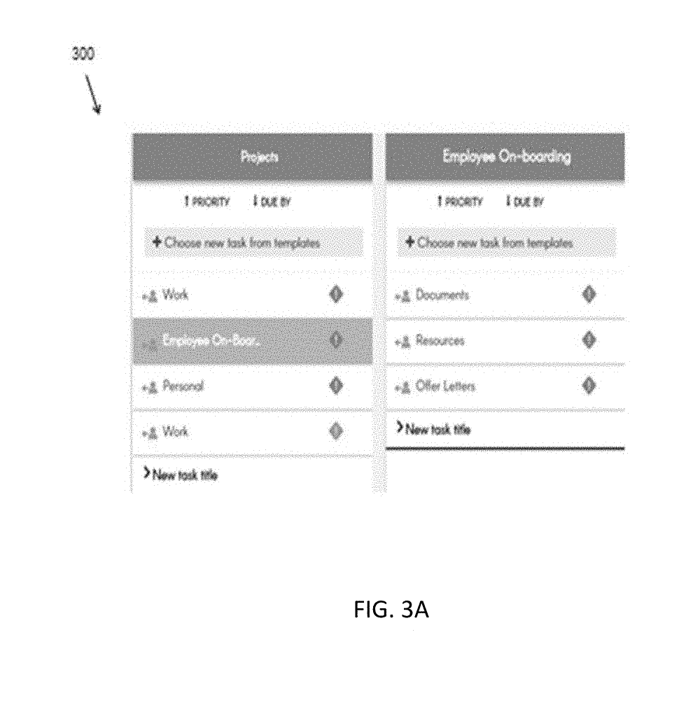

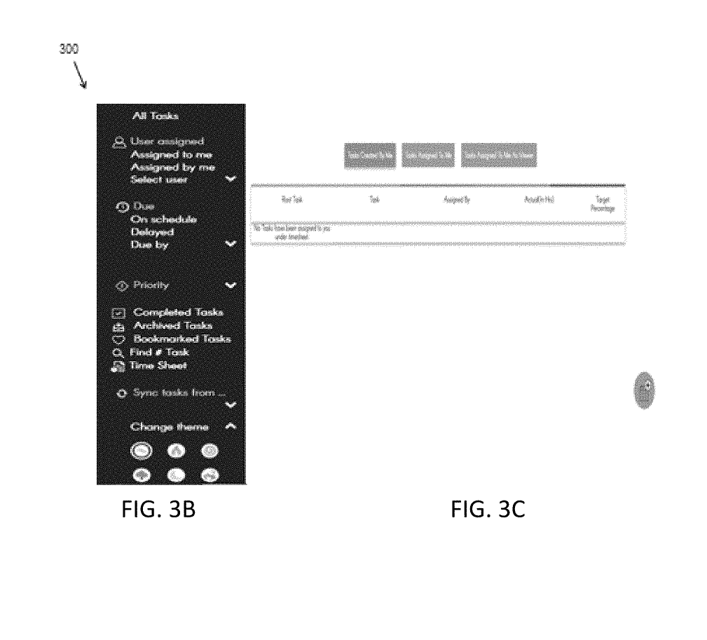

FIG. 2 illustrates a method (200) for task management in accordance with an embodiment of the present disclosure. The method (200) begins at step 202, by receiving a plurality of tasks generated at the first user device (108) corresponding to a first user. Further, the first user device (108) is one of, but not limited to, a mobile handheld device, a laptop, a desktop pc and a tablet. Further, the first user is, but not limited to, a manager and a team leader. Further, the plurality of tasks has been divided into a hierarchical structure having a plurality of levels, execution of a task at one level being dependent on execution of another task at a subordinate level. For instance, a task having title ‘A’ which is further divided into a plurality of sub tasks having titles ‘B’ and ‘C’. The sub task having title ‘B’ is further divided into a plurality of sub-sub tasks having titles ‘E’ and ‘F’. Here, execution of the sub task having title ‘B’ is dependent on the execution of the sub-sub tasks having titles ‘E’ and ‘F’. The sub task ‘C’ is further into the plurality of sub-sub tasks having title ‘G’ and ‘H’. Here, execution of sub task having title ‘C’ is dependent on the execution of the sub-sub tasks having title ‘G’ and ‘H’. Further, execution of the task having title ‘A’ is dependent on the execution of the plurality of sub tasks having titles ‘B’ and ‘C’. Referring to FIG. 3A, that illustrates a snapshot of the plurality of tasks (300) in accordance with an embodiment of the disclosure. Herein, the plurality of tasks is configured to create up to an infinite level. Further, the execution of a task at one level is dependent on execution of another task at a subordinate level.

The server (102) processes the plurality of tasks to ensure that the respective plurality of tasks is accurately sorted such that the plurality of tasks received by the server (102) is assigned correctly to the plurality of second users.

At step 204, a plurality of assignment schedules is received corresponding to the plurality of respective tasks, from the first user device (108). The plurality of assignment schedules comprises a plurality of respective tasks to the plurality of second users, on basis of a plurality of parameters. Further, the plurality of parameters comprises, but not limited to, respective designations, skill levels, availabilities and locations of the plurality of second users.

At step 206, the plurality of tasks is assigned to a plurality of second users, on basis of the plurality of assignment schedules. Further, the plurality of tasks and the plurality of assignment schedules are stored in a storage device (104). Referring to FIG. 3B, that illustrates a snapshot of a plurality of options (300) in accordance with an embodiment of the present disclosure. As shown in FIG. 3B, the plurality of options comprises, but not limited to, the plurality of completed tasks, a plurality of archived tasks, a plurality of hash tags, a plurality of bookmarked tasks and a timesheet. Further, data related to the plurality of options is configured to store in the storage device (104).

In accordance with an embodiment, the storage device (104) is further configured to store data regarding the one or more second users, of the plurality of second users such as, but not limited to, education proofs, identity proofs, photographs, medical and signed non-disclosure agreement (NDA).

In accordance with an embodiment of the disclosure, one or more tasks, of the plurality of tasks, are assigned to a second user, of the plurality of second users. Further, one or more responses is received corresponding to the one or more respective tasks, from the second user device.

Referring to FIG. 3C, that illustrates a snapshot of the timesheet (300) in accordance with an embodiment of the disclosure. The timesheet is configured to record an amount of time spent on a task, of the plurality of tasks by a second user, of the plurality of second users. The timesheet is further configured to show, but not limited to, the plurality of tasks created, the plurality of tasks assigned by the second user, of the plurality of second users and the plurality of tasks assigned to the second user as a viewer.

At step 208, a plurality of second user devices (110(A), 110(B), 110(n)) is notified corresponding to the plurality of respective second users, of the plurality of tasks. The plurality of second users is notified through a cloud based calendar service. The plurality of second users is capable of customizing and integrating a notification on such as, but not limited to, Google drive, Google calendar and e-mail. For instance, the plurality of options is provided through which the plurality of second users is able to upload the plurality of tasks on e-mail, download the plurality of tasks from e-mail, upload the plurality of tasks on Google calendar and download the plurality of tasks from Google calendar.

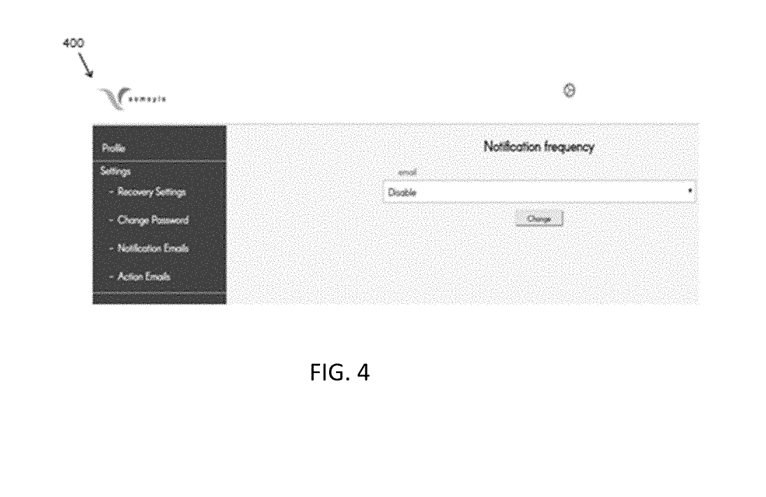

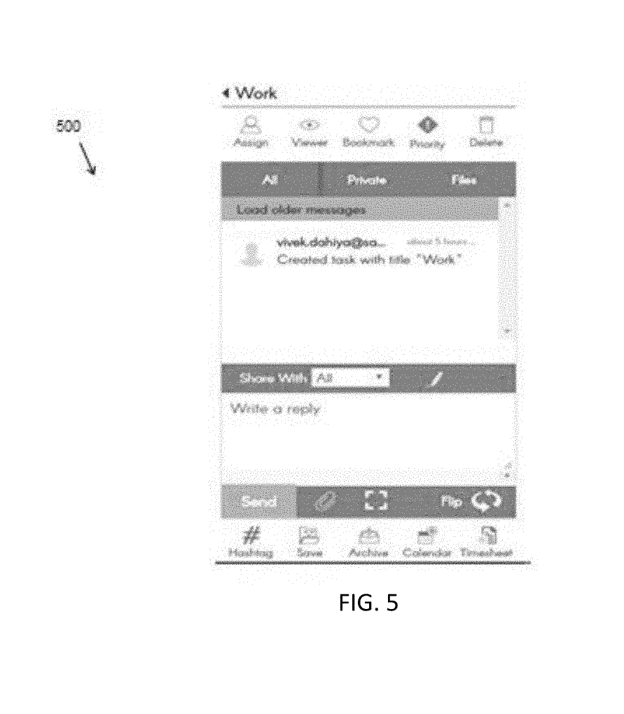

Referring to FIG. 4, that illustrates a snapshot of the plurality of options for the notification in the drop down menu (400) in accordance with an embodiment of the present disclosure. The plurality of options for the notification in the drop down menu is, but not limited to, disable, twice a day, every day, twice a week and every week. Further, the plurality of second users is capable of selecting the option from the drop down menu in order to set the notification.

In accordance with an embodiment of the disclosure, a task, of the plurality of tasks, is assigned to one or more second users, of the plurality of second users. Further, one or more responses is received corresponding to the task from the one or more respective second user devices (110(A), 110(B), 110(n)).

In accordance with an embodiment, a plurality of priority ratings is received corresponding to the plurality of tasks, from the plurality of second user devices (110(A), 110(B), 110(n)). Herein 5 types of the plurality of priority ratings are provided i.e. L5-L1. L5 being highest priority and L1 being lowest priority.

In accordance with embodiment of the disclosure, the messaging channel is provided between the first user device (108) and a second user device, of the plurality of second user devices (110(A), 110(B), 110(n)). The messaging channel is provided for communication between the first user device 108 and a second user device, of the plurality of second user devices (110(A), 110(B), 110(n)). In one embodiment, the communication is a private communication. In another embodiment, the communication is a public communication. Referring to FIG. 5, that illustrates a snapshot of the messaging channel (500) in accordance with an embodiment of the present disclosure. Here, the first user and the one or more second users, of the plurality of second users are capable of communicating with each other. Further, the messaging channel is configured to extract older messages from the storage device (104). Furthermore, the first user and the one or more users, of the plurality of second users is configured to share, but not limited to, file links and files. Further, the shared file links and files are viewed through the interface of a window.

In accordance with embodiment of the disclosure, a plurality of progress reports is generated corresponding to the plurality of respective tasks and transmitting the plurality of tasks to the first user device with the help of the server (102) that is connected to the network (104).

At step 210, progress information is received corresponding to the plurality of tasks from the plurality of second user devices (110 (A), 110(B), 110(n)).

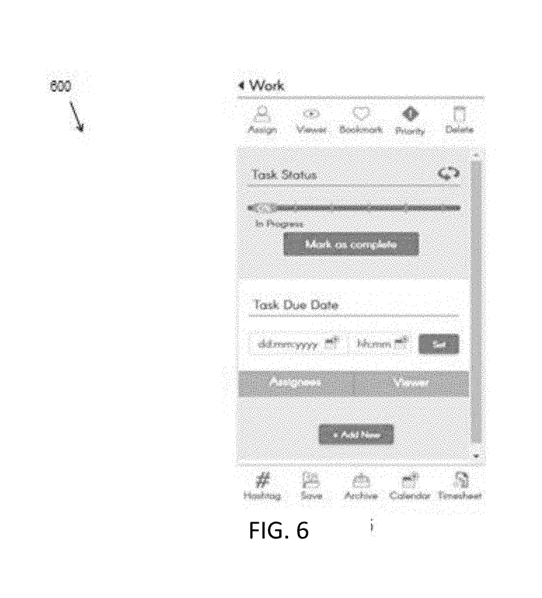

In accordance with embodiment of the disclosure, a task, of the plurality of tasks, and a respective progress report, of the plurality of progress reports is displayed at the first user device (108), the task being displayed in a first window and the progress report being displayed in a second window, wherein the first window and the second window are displayed in alternative, at the first user device (108). Referring to FIG. 6, that illustrates a snapshot of the progress report (600) in accordance with an embodiment of the disclosure. The plurality of progress report is based on, but not limited to, meet task end date, task expected date, and make reliable hours estimations for completion of past tasks.

In accordance with embodiment of the disclosure, a transfer of ownership of one or more of the plurality of tasks is received from the first user device; the ownership is being transferred from the first user to another first user.

In one embodiment, the plurality of options is configured to change an appearance of the first user device (108) and the second user device, of the plurality of second user devices (110 (A), 110(B), 110(n)). Further, the plurality of options is configured to, but not limited to, add new task, delete new task and change the plurality of priority ratings and the e-mail. Further, on selecting the e-mail option, the plurality of second users is displayed corresponding to the task, of the plurality of tasks. Further, the e-mail option is configured to send the e-mail to the one or more respective second user devices corresponding to the task. Furthermore, in case, the second user, of the plurality of second users is not displayed then the e-mail option is further configured to add the second user, of the plurality of second users.

In another embodiment, another option is selected to add a hag tag in order to identify specific task. In preferred embodiment, referring to FIG. 5 and FIG. 6, the plurality of options is further provided to flip a portion of the window of the first user device (108) and the second user device, of the plurality of second user devices (110 (A), 110(B), 110(n)) in order to display a status of completion of the plurality of tasks by the plurality of second users.

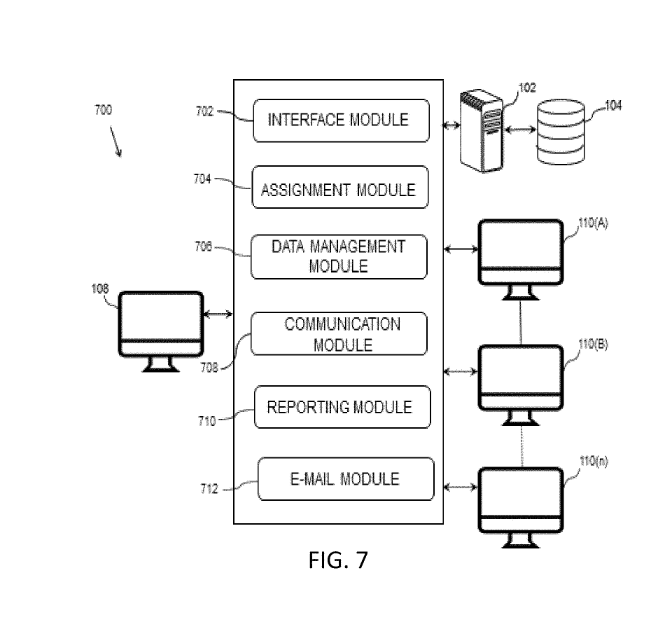

FIG. 7 illustrates a system (700) for task management in accordance with an embodiment of the present disclosure. As shown in FIG. 7, a system (700) for task management comprises an interface module (702), an assignment module (704) and a data management module (706). The interface module (702) is configured to receive a plurality of tasks generated at a first user device (108) corresponding to a first user. Further, the interface module (702) is configured to receive a plurality of assignment schedules corresponding the plurality of respective tasks, from the first user device (108). In accordance with an embodiment, the interface module (702) is further configured to receive one or more responses corresponding to the one or more respective tasks, from the second user device. Further, the interface module (702) is configured to receive one or more responses corresponding to the task from the one or more respective second user devices (110 (A), 110(B), 110(n)). Furthermore, the interface module (702) is configured to display a task, of the plurality of tasks, and a respective progress report, of the plurality of progress reports, at the first user device (108), the task being configured to be displayed in a first window and the progress report being configured to be displayed in a second window, wherein the first window and the second window are configured to be displayed in alternative, at the first user device (108).

In accordance with an embodiment, the assignment module (704) is configured to assign the plurality of tasks to a plurality of second users, on basis of the plurality of assignment schedules. Further, assignment module (704) is configured to notify a plurality of second user devices (110 (A), 110(B), 110(n)) corresponding to the plurality of respective second users, of the plurality of tasks. The assignment module (704) is configured to assign one or more tasks, of the plurality of tasks, to a second user, of the plurality of second users. Further, the assignment module (704) is configured to assign a task, of the plurality of tasks, to one or more second users, of the plurality of second users. Further, the assignment module (704) is configured to notify the plurality of second users through a cloud based calendar service.

In accordance with an embodiment, the data management module (706) is configured to receive progress information corresponding to the plurality of tasks from the plurality of second user devices (110 (A), 110(B), 110(n)). The data management module (706) module is further configured to store the plurality of tasks and the plurality of assignment schedules in a storage device (104). Further, the data management module (706) is configured to receive a plurality of priority ratings corresponding to the plurality of tasks, from the plurality of second user devices (110 (A), 110(B), 110(n)). Further, the data management module (706) is configured to receive a transfer of ownership of one or more of the plurality of tasks from the first user device (108), the ownership being transferred from the first user to another first user.

In accordance with an embodiment, the system further comprises a communication module (708) configured to provide a messaging channel between the first user device (108) and a second user device, of the plurality of second user devices (110 (A), 110(B), 110(n)).

In accordance with an embodiment, the system further comprises a reporting module (710) configured to generate a plurality of progress reports corresponding to the plurality of respective tasks and transmit the plurality of progress reports to the first user device (108).

In accordance with an embodiment, the plurality of tasks has been divided into a hierarchical structure having a plurality of levels, execution of a task at one level being dependent on execution of another task at a subordinate level.

In accordance with an embodiment, the plurality of assignment schedules comprises a plurality of respective time schedules corresponding to the plurality of respective tasks.

In accordance with an embodiment, the plurality of assignment schedules comprises assignment of the plurality of respective tasks to the plurality of second users, on basis of a plurality of parameters. Further, the plurality of parameters comprises, but not limited to, respective designations, skill levels, availabilities and locations of the plurality of second users.

In accordance with an embodiment, the system further comprises e-mail module configured to send e-mail to the one or more respective second user devices corresponding to the task.

Further, the system (700) is configured to run on web browser such as, but not limited to, Google chrome and Firefox. Further, the web browser user interface is written in languages such as, but not limited to, JavaScript, Hypertext markup language (HTML) and Cascading style sheets (CSS).

It is to be noted here that the server (102) is contemplated to have computing capabilities such as, but not limited to, a control unit, a memory unit, a communication interface and a bus connecting the control unit, the memory unit and the communication interface. Further, the configuration of the server (102) for undertaking the methods and processes involved in the present disclosure may be achieved through execution, by the control unit, of the machine-readable instructions fed into the memory unit. Additionally, the configuration of the server (102) may also be achieved through one or more additional modules.

In general, the word “module,” as used herein, refers to logic embodied in hardware or firmware, or to a collection of software instructions, written in a programming language, such as, for example, Java, C, or assembly. One or more task management software instructions in the modules may be embedded in firmware, such as an EPROM. It will be appreciated that modules may comprised connected logic units, such as gates and flip-flops, and may comprise programmable units, such as programmable gate arrays or the control unit. The modules described herein may be implemented as either software and/or hardware modules and may be stored in any type of computer-readable medium or other computer storage device.

Various modifications to these embodiments are apparent to those skilled in the art from the description. The principles associated with the various embodiments described herein may be applied to other embodiments. Therefore, the description is not intended to be limited to the embodiments but is to be providing broadest scope of consistent with the principles and the novel and inventive features disclosed or suggested herein. Accordingly, the disclosure is anticipated to hold on to all other such alternatives, modifications, and variations that fall within the scope of the present disclosure and appended claims.

What is claimed is:

1. A method (200) for task management, comprising steps of:
receiving (202) a plurality of tasks generated at a first user device (108) corresponding to a first user;
receiving (204) a plurality of assignment schedules corresponding the plurality of respective tasks, from the first user device (108);
assigning (206) the plurality of tasks to a plurality of second users, on basis of the plurality of assignment schedules;
notifying (208) a plurality of second user devices (110 (A), 110(B), 110(n)), corresponding to the plurality of respective second users, of the plurality of tasks; and
receiving (210) progress information corresponding to the plurality of tasks from the plurality of second user devices (110 (A), 110(B), 110(n)).

2. The method as claimed in claim 1, wherein the plurality of tasks has been divided into a hierarchical structure having a plurality of levels, execution of a task at one level being dependent on execution of another task at a subordinate level.

3. The method as claimed in claim 1, wherein the plurality of assignment schedules comprises a plurality of respective time schedules corresponding to the plurality of respective tasks.

4. The method as claimed in claim 1, wherein the plurality of assignment schedules comprises assignment of the plurality of respective tasks to the plurality of second users, on basis of a plurality of parameters.

5. The method as claimed in claim 4, wherein the plurality of parameters comprises respective designations, skill levels, availabilities and locations of the plurality of second users.

6. The method as claimed in claim 1, further comprising a step of storing the plurality of tasks and the plurality of assignment schedules in a storage device (104).

7. The method as claimed in claim 1, further comprising a step of providing a messaging channel between the first user device (108) and a second user device, of the plurality of second user devices (110 (A), 110(B), 110(n)).

8. The method as claimed in claim 1, wherein one or more tasks, of the plurality of tasks, are assigned to a second user, of the plurality of second users.

9. The method as claimed in claim 8, further comprising a step of receiving one or more responses corresponding to the one or more respective tasks, from the second user device.

10. The method as claimed in claim 1, wherein a task, of the plurality of tasks, is assigned to one or more second users, of the plurality of second users.

11. The method as claimed in claim 10, further comprising a step of receiving one or more responses corresponding to the task from the one or more respective second user devices (110 (A), 110(B), 110(n)).

12. The method as claimed in claim 1, further comprising a step of receiving a plurality of priority ratings corresponding to the plurality of tasks, from the plurality of second user devices (110 (A), 110(B), 110(n)).

13. The method as claimed in claim 1, wherein the plurality of second users is notified through a cloud based calendar service.

14. The method as claimed in claim 1, further comprising a step of receiving a transfer of ownership of one or more of the plurality of tasks from the first user device 108, the ownership being transferred from the first user to another first user.

15. The method as claimed in claim 1, further comprising a step of generating a plurality of progress reports corresponding to the plurality of respective tasks and transmitting the plurality of tasks to the first user device (108).

16. The method as claimed in claim 15, further comprising a step of displaying a task, of the plurality of tasks, and a respective progress report, of the plurality of progress reports, at the first user device (108), the task being displayed in a first window and the progress report being displayed in a second window, wherein the first window and the second window are displayed in alternative, at the first user device (108).

17. The method as claimed in claim 1, further comprising a step of sending e-mail to the one or more respective second user devices corresponding to the task.

18. A system (700) for task management, comprising:
an interface module (702);
an assignment module (704); and
a data management module (706);
wherein the interface module (702) is configured to:
receive a plurality of tasks generated at a first user device (108) corresponding to a first user;
receive a plurality of assignment schedules corresponding the plurality of respective tasks, from the first user device (108);
wherein the assignment module (704) is configured to:
assign the plurality of tasks to a plurality of second users, on basis of the plurality of assignment schedules;
notify a plurality of second user devices, corresponding to the plurality of respective second users, of the plurality of tasks; and
wherein the data management module (706) is configured to:
receive progress information corresponding to the plurality of tasks from the plurality of second user devices (110 (A), 110(B), 110(n)).

19. The system (700) as claimed in claim 18, wherein the plurality of tasks has been divided into a hierarchical structure having a plurality of levels, execution of a task at one level being dependent on execution of another task at a subordinate level.

20. The system (700) as claimed in claim 18, wherein the plurality of assignment schedules comprises a plurality of respective time schedules corresponding to the plurality of respective tasks.

21. The system (700) as claimed in claim 18, wherein the plurality of assignment schedules comprises assignment of the plurality of respective tasks to the plurality of second users, on basis of a plurality of parameters.

22. The system (700) as claimed in claim 21, wherein the plurality of parameters comprises respective designations, skill levels, availabilities and locations of the plurality of second users.

23. The system (700) as claimed in claim 18, wherein the data management module (706) is further configured to store the plurality of tasks and the plurality of assignment schedules in a storage device.

24. The system (700) as claimed in claim 18, further comprising communication module (708) configured to provide a messaging channel between the first user device (108) and a second user device, of the plurality of second user devices (110 (A), 110(B), 110(n)).

25. The system (700) as claimed in claim 18, wherein the assignment module (704) is further configured to assign one or more tasks, of the plurality of tasks, to a second user, of the plurality of second users.

26. The system (700) as claimed in claim 25, wherein the interface module (702) is further configured to receive one or more responses corresponding to the one or more respective tasks, from the second user device.

27. The system (700) as claimed in claim 18, wherein the assignment module (704) is further configured to assign a task, of the plurality of tasks, to one or more second users, of the plurality of second users.

28. The system (700) as claimed in claim 27, wherein the interface module (702) is further configured to receive one or more responses corresponding to the task from the one or more respective second user devices (110 (A), 110(B), 110(n)).

29. The system (700) as claimed in claim 18, wherein the data management module (706) is further configured to receive a plurality of priority ratings corresponding to the plurality of tasks, from the plurality of second user devices (110 (A), 110(B), 110(n)).

30. The system (700) as claimed in claim 18, wherein assignment module (704) is further configured to notify the plurality of second users through a cloud based calendar service.

31. The system (700) as claimed in claim 18, wherein the data management module (706) is further configured to receive a transfer of ownership of one or more of the plurality of tasks from the first user device (108), the ownership being transferred from the first user to another first user.

32. The system (700) as claimed in claim 18, further comprising reporting module (710) configured to generate a plurality of progress reports corresponding to the plurality of respective tasks and transmit the plurality of progress reports to the first user device (108).

33. The system (700) as claimed in claim 32, wherein the interface module (702) is further configured to display a task, of the plurality of tasks, and a respective progress report, of the plurality of progress reports, at the first user device (108), the task being configured to be displayed in a first window and the progress report being configured to be displayed in a second window, wherein the first window and the second window are configured to be displayed in alternative, at the first user device (108).

34. The system (700) as claimed in claim 18, further comprising e-mail module (712) configured to send e-mail to the one or more respective second user devices corresponding to the task.
